(19) United States
(12) Patent Application Publication
(10) Pub. No.: US 2012/0058043 A1
(43) Pub. Date: Mar. 8, 2012

(54) PROCESSES AND DEVICES FOR REMOVING RUTHENIUM AS RuO4 FROM RUTHENATE-CONTAINING SOLUTIONS BY DISTILLATION

(75) Inventors: HORST MEYER, ALTENSTADT (DE); MATTHIAS GREHL, GOLDBACH (DE); HANS-JOACHIM ALT, BRUCHKOEBEL (DE); PETER PATZELT, ASCHAFFENBURG (DE); HERMANN VON EIFF, NEUBERG (DE); BERND ZELL, RODENBACH (DE)

(73) Assignee: W.C. HERAEUS GMBH, Hanau (DE)

(21) Appl. No.: 13/295,995

(22) Filed: Nov. 14, 2011

Related U.S. Application Data
(63) Continuation of application No. 12/358,323, filed on Jan. 23, 2009, now abandoned.

(30) Foreign Application Priority Data
Jan. 30, 2008 (DE) 10 2008 006 797.0

(51) Int. Cl. C01G 55/00; B01J 19/18

(52) U.S. Cl. 423/592.1; 422/224

(57) ABSTRACT

In processes for removing ruthenium by distilling RuO₄ from ruthenate-containing solutions with these steps of
the treatment of the ruthenate-containing solution with an oxidising agent,
distilling off of the RuO₄ formed,
absorbing the RuO₄ from step II in hydrochloric acid,
   the oxidising agent is recycled into step I following step III.

The processes can be carried out in reactor modules with
A a reactor with a stirrer, gas inlet and gas outlet,
B at least one scrubber connected in series downstream with the gas outlet via a line,
C one or several gas absorbers connected in series downstream with the at least one scrubber via lines,
E at least one line from the optionally last absorber
   for recycling into the gas inlet of the reactor
   or into a further module
   or into a facility for off-gas treatment.

The invention relates to processes and devices for removing ruthenium as RuO₄ from ruthenate-containing solutions by distillation.

Parting products containing ruthenium (and, if applicable, osmium) are treated initially with an alkaline oxidising melt, for example, to recover the noble metals. Following leaching, solutions are obtained therefrom which contain K₂RuO₄ (and, if applicable, K₂OsO₄). The elements Ru and Os are advantageously partitioned oxidatively as tetroxides. Suitable oxidising agents for this purpose are e.g. oxygen/ozone, H₂O₂/sulphuric acid, peroxodisulphate, bromine or chlorine. The tetroxides are separated off by distillation.

From JP61006130A, it is known to saturate ruthenate-containing aqueous solutions from alkaline melt leaching with chlorine gas, to decompose the hypochlorite formed by acidification, to distil off RuO₄ and to take it up in HCl. A yield of 99% is indicated as being obtained on a laboratory scale.

To liberate RuO₄, chlorine is consumed:

2K⁺+RuO₄²⁻+Cl₂--->RuO₄+2KCl (I)

During absorption in HCl, twice the quantity of chlorine is liberated:

RuO₄+10HCl--->H₂RuCl₆+2Cl₂+4H₂O (II)

When an oxidising agent such as chlorine or a chlorine/air mixture is passed through the ruthenate-containing solution on an industrial scale and acts as entrainer for RuO₄, a large quantity of oxidising agent is consumed in the process.

The invention attempts above all to remedy this problem. It has the object of providing a process for removing ruthenium as RuO₄ from ruthenate-containing solutions by distillation, in which process the oxidising agent is used as efficiently as possible with a high yield.

A further object is the provision of a process suitable for automation.

The object is achieved by way of processes according to claim 1. Advantageous embodiments can be found in the further claims.

In this process, the oxidising agent, e.g. a chlorine/air mixture, is recycled within a distillation facility.

Advantageously, the reactor is heatable and coolable such that the temperature development can be controlled in an automated manner.

It is advantageous to connect several distillation facilities in series as modules. Appropriately, the process is controlled in such a way that as soon as excess oxidising agent, e.g. chlorine, is developed in a facility, its gas mixture is pumped into the next facility. In this way, if chlorine is used as oxidising agent, chlorine produced in the process, too, is utilised for the oxidation of ruthenate. With this method of operation, approximately 1.9 kg of chlorine per kg of Ru, for example, are introduced from outside. As a result of the recycling operation, approximately 0.2 kg of chlorine per kg of Ru pass into the off-gas purification facility.

If the pH of the alkaline ruthenate-containing solution is reduced with acid before introducing the chlorine, the violence of the reaction is easier to control.

It has proved to be advantageous to keep the concentration of hydrochloric acid in which RuO₄ is taken up at a high level, appropriately above 5 mole/l, by introducing HCl gas to prevent RuO₄ from accumulating.

Appropriately, the process is integrated into a procedure for recovering ruthenium from partitioning products. In this case, the absorbed H₂RuCl₆ and the mother liquors which have arisen are worked up in a manner known to the expert.

The process according to the invention is elucidated by way of the following example. Parts and percentages relate to the weight, as they do in the rest of the description, unless indicated otherwise.

### EXAMPLE

A ruthenium-containing melt cake from the alkaline oxidising melt is leached with non-potable water with stirring. The potassium/sodium ruthenate solution obtained is introduced into a glass flask and subsequently pumped into a receiving vessel.

A 500 l reactor with a gas inlet, stirrer, gas outlet and a 50 l washing flask connected to it, which flask is connected to four absorber receiving vessels connected in series and filled with concentrated HCl (first receiving vessel), diluted HCl (2nd and 3rd receiving vessel) and water (4th receiving vessel) is supplied with 50-80 l of the potassium/sodium ruthenate solution and filled with service water to a level of 300 l. Depending on the predetermined concentration of potassium/sodium ruthenate solution, 5-10 l of concentrated technical grade HNO₃ are added to the solution and the temperature is raised to 50° C.

2.5 m³/h of chlorine are introduced into the solution via an inlet pipe. On termination of the temperature hike, heating is carried out.

All the liquid ruthenium tetroxide that has collected at the bottom of the distillation flask is distilled off and collected in the receiving vessels.

Before the end of the RuO₄ distillation, HCl gas is introduced into the first receiving vessel.

RuO₄ reacts to form H₂RuCl₆ according to equation (II) in this process. The introduction is started once a temperature 80-85° C. has been reached in the distillation flask.

The reaction is terminated when the washing water in the washing flask becomes almost colourless, a temperature of at least 98° C. has been reached in the reactor and no further RuO₄ is visible at the bottom of the washing flask.

The stream of chlorine is interrupted.

The stream of HCl into the receiving vessels is maintained for a further 1-2 h.

The residue in the reactor is treated with 3-4 l of 45-50% technical grade NaOH. The H₂RuCl₆/RuCl₃ solution obtained is removed from the absorber receiving vessels.

The invention also relates to devices according to claim 9 for carrying out the process described.

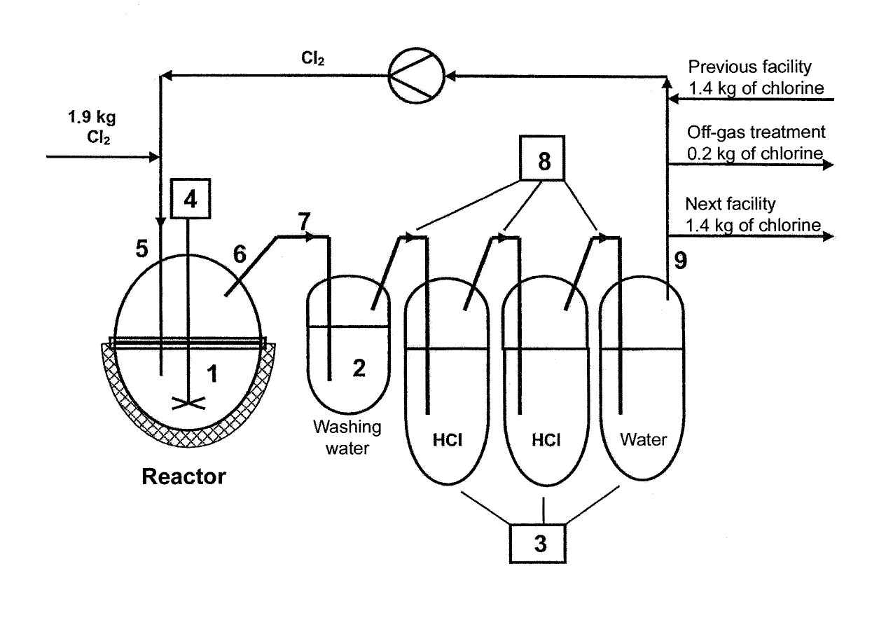

FIG. 1 shows a module of an exemplary device for executing the process.

In the case of the module, a washing flask 2 is connected in series downstream to a reactor 1 with a stirrer 4, gas inlet 5 and gas outlet 6, in which washing flask the gas/vapour mixture distilled off is freed from possible salt mists originating from the reaction mixture. A line leads from the outlet of the gas scrubber to one or several absorbers 3 optionally connected in series. As regards the module of FIG. 1, several of it may be connected in series and jointly form a device for executing the process according to the invention. Optionally, the gas is recycled into the reactor through the outlet of the last absorber of a module or passed into a further module or into a facility for off-gas treatment. It goes without saying that the off-gas treatment is carried out only after the last module of the device.

It is illustrated in the exemplary embodiment of the module of FIG. 1 that 1.9 kg of chlorine are supplied from outside and 1.4 kg of chlorine arrive from a facility connected in front. Correspondingly, 1.4 kg of chlorine leaves this module in order to participate in the reaction in a facility connected in series downstream.

It has proved appropriate for the gasket of the stirrer 4, e.g. a sliding ring gasket, to be flushed with chlorine gas in order to avoid corrosion by RuO₄ penetrating into the gasket space.

1. A process for removing ruthenium by distilling Ru0₄ from ruthenate-containing solutions comprising the steps of
I. treating the ruthenate-containing solution with an oxidising agent,
II. distilling off the Ru0₄ formed,
III. absorbing the Ru0₄ from step II in hydrochloric acid,
wherein the oxidizing agent is recycled after at least one cycle into at least one further process connected in series with further steps I to III, and wherein the oxidising agent is optionally the oxidising agent is recycled into step I following step III.

2. (canceled)

3. The process according to one of the preceding claims in which the oxidising agent is selected from the group consisting of oxygen/ozone, H₂O₂/sulphuric acid, peroxodisulphate, bromine and chlorine.

4. The process according to claim 1 wherein a mineral acid is added before step I.

5. The process according to claim 6 wherein the oxidising agent is bromine or chlorine.

6. The process according to claim 2 wherein the gas mixture is passed after step III into a process connected in series downstream when the oxidizing agent begins to develop after step III.

7. The process according to claim 5 wherein the chlorine is freed from HCI gas by washing with water before recycling.

8. The process according to one of the preceding claims 5 in which hydrochloric acid and/or nitric acid is added before step I.

9. A device for carrying out processes according to claim 1 said device comprising:
A. a reactor (1) with stirrer (4), gas inlet (5) and gas outlet,
B. at least one scrubber (2) connected in series downstream with the gas outlet (6) via line (7),
C. at least one gas absorber (3) connected in series downstream with at least one scrubber (2) via lines (8),
E. at least one line (9) from the optionally last absorber for recycling into the gas inlet of the reactor (1) or into a further module or into a facility for off-gas treatment.

10. The device according to claim 9 in which a separate gas inlet is present on the stirrer (4) for producing a chlorine or bromine gas atmosphere in the space around the gasket of the stirrer.

11. A process for removing ruthenium by distilling Ru0₄ from ruthenate-containing solutions comprising the steps of
(a) providing a module comprising of distillation facilities connected in series, wherein each of said distillation facilities comprise a reactor, at least one scrubber, and at least one absorber;
(b) treating the ruthenate-containing solution with chlorine,
(c) distilling off the Ru0₄ formed,
(d) absorbing the Ru0₄ from step II in hydrochloric acid,
wherein the chlorine is recycled after at least one cycle into at least one further distillation facility connected in series, and wherein the chlorine is freed from HCI gas by washing with water before recycling.

12. The process according to claim 11 wherein the oxidising agent is selected from the consisting of oxygen/ozone, H₂O₂/sulphuric acid, peroxodisulphate, bromine and chlorine.

13. The process according to claim 11 wherein a mineral acid is added before step (b).

14. The process according to claim 11 wherein the oxidising agent is bromine or chlorine.

15. The process according to claim 11 wherein the chlorine is freed from HCI gas by washing with water before recycling.
